(19) United States
(12) Patent Application Publication
(10) Pub. No.: US 2009/0320533 A1
(43) Pub. Date: Dec. 31, 2009

(54) FASTENER AND LOCKING STRUCTURE FOR PORTABLE ELECTRONIC DEVICE

(75) Inventors: ZHUO-GUANG RUAN, Foshan (CN); WEN-FU WEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/331,437

(22) Filed: Dec. 10, 2008

(30) Foreign Application Priority Data
Jun. 27, 2008 (CN) 200810302411.0

(51) Int. Cl. E05B 73/00

(52) U.S. Cl. 70/58; 292/288

(57) ABSTRACT

An exemplary locking structure for a portable electronic device includes an engagement portion and a fastener. The engagement portion includes an upper plate and a lateral plate perpendicular to the upper plate. Two protrusions are fixed on a fringe of the upper plate and lateral plate. The lateral plate defines a through hole. The fastener includes a main body, a first holding sheet, two second holding sheets, and a third holding sheet. The main body abuts the lateral plate. The first and second holding sheets extend from the upper plate in a first direction and the second holding sheets are engaged with the protrusions. The third holding sheet extends from a bottom end of the main body and passes through the through hole so that a locking hole of the third holding sheet is exposed outside of the housing.

### BACKGROUND

1. Technical Field

The present disclosure relates to fasteners and locking structures and, particularly, to a fastener and a locking structure for a portable electronic device.

2. Description of the Related Art

In many situations, a portable electronic device needs to be safely locked to some kind of fixed structure when the portable electronic device is not in use. For example, when a portable electronic device such as a projection device is on public display in a shop or at an exhibition, it is desirable that the projection device be secured to a shelf or display cabinet to prevent the projection device from being stolen. One means to achieve this is by providing a locking slot in a housing of the projection device, and providing a corresponding locking strap. One end of the locking strap is fixed to the shelf or display cabinet etc, and the other end of the locking strap has a locking element that can lockingly engage in the locking slot. The locking element may for example include a T-shaped anchor (i.e., with flukes). The whole T-shaped anchor is inserted through the locking slot in one orientation. Then, when the locking strap with the T-shaped anchor is rotated 90°, the flukes engage with the inner wall of the housing and prevent the housing from disengaging from the locking strap.

One drawback of the above-described locking means is that the T-shaped anchor must be configured to properly match the locking slot of the projection device. Therefore a different projection device may require a different T-shaped anchor and accompanying locking strap. The need for another T-shaped anchor for a different projection device is liable to add to costs.

Therefore, it is desirable to provide a locking structure which can overcome the problems described.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the fastener and locking structure for the portable electronic device. Moreover, in the drawings, like reference numerals designate corresponding parts throughout the several views.

FIG. 1 is an isometric, exploded view showing a locking structure according to an exemplary embodiment, the locking structure including a fastener.

FIG. 2 is another isometric, exploded view showing the locking structure according to the exemplary embodiment, viewed at another angle.

FIG. 3 is an isometric, enlarged view of the fastener of FIG. 2.

FIG. 4 is an isometric, assembled view of the locking structure shown in FIG. 1.

FIG. 5 is an isometric, assembled view of the locking structure shown in FIG. 2.

### DETAILED DESCRIPTION OF EMBODIMENTS

Embodiments of the fastener and locking structure for the portable electronic device are described in detail herein with reference to the drawings.

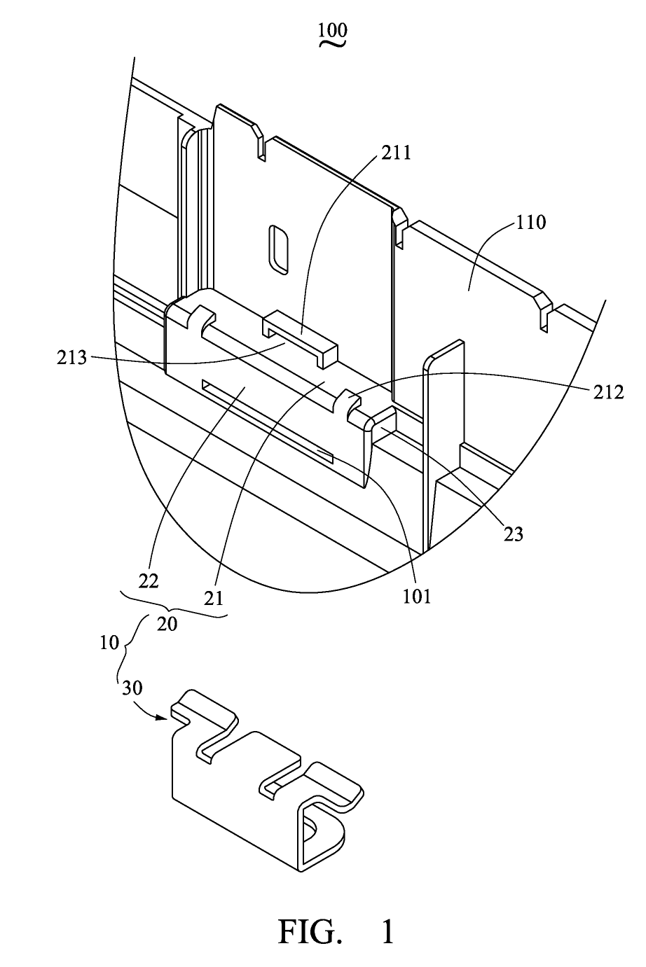

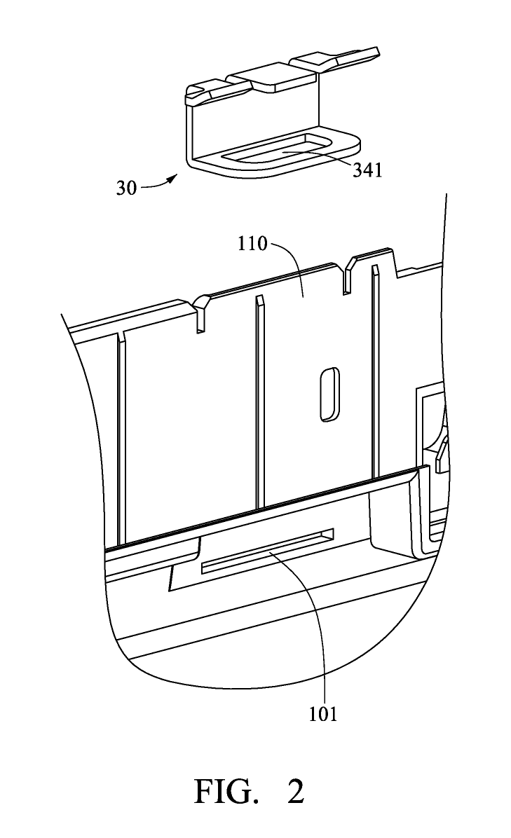

FIGS. 1-2 show a locking structure 10 of an exemplary embodiment employed in a portable electronic device 100 such as a projection device. The portable electronic device 100 includes a housing 110. The locking structure 10 includes an engagement portion 20 and a fastener 30. The engagement portion 20 is an integral part of the housing 110 or is attached to the housing 110, and includes an upper plate 21 and a lateral plate 22 perpendicular to the upper plate 21. The upper plate 21 extends from or is fixed to an inner surface of the housing 110. The lateral plate 22 defines a through hole 101 passing through the housing 110. The through hole 101 can be, for example, a rectangular through slot. A part of the fastener 30 defines a locking hole 341. The fastener 30 is engaged with the engagement portion 20, with a part of the fastener 30 including the locking hole 341 being inserted through the through hole 101 and thereby being exposed to the outside of the housing 110. In this manner, the locking structure 10 is formed. The locking hole 341 of the locking structure 10 enables the portable electronic device 100 to be conveniently locked to a fixed structure such as a locking loop provided on the wall of a display cabinet. In particular, a device such as a padlock can be engaged through both the locking hole 341 and the locking loop. In another example, the fixed structure may be the end of a chain, with an opposite end of the chain fixed to the wall of the display cabinet.

The upper plate 21 includes a receiving element 211 extending up from a main body 23 thereof, or fixed on the main body 23. Two curved protrusions 212 spaced from the receiving element 211 extend up from a fringe of the upper plate 21 and the lateral plate 22. The protrusions 212 may integrally extend up from the fringe, or may be fixed on the fringe. In the illustrated embodiment, the receiving element 211 includes a hole 213 aligned in a same horizontal level with the protrusions 212. That is, a height of the hole 213 is substantially the same as a height (or thickness) of the protrusions 212. The hole 213 can be, for example, a rectangular slot. The number of protrusions 212 is not limited by this embodiment, and can, alternatively, be one or more than two.

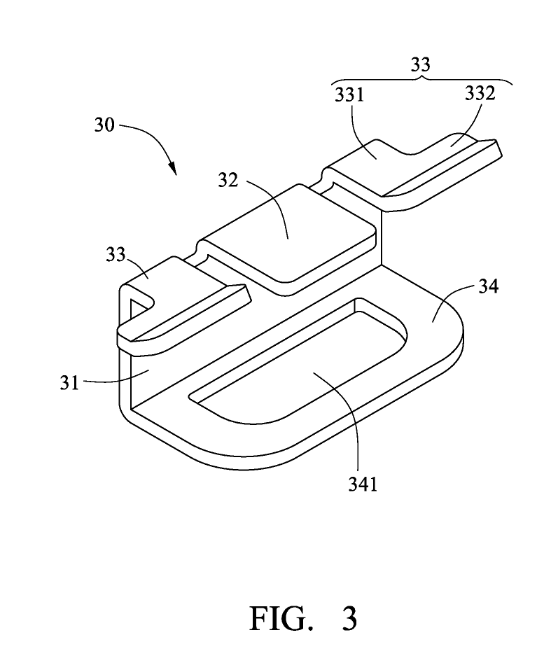

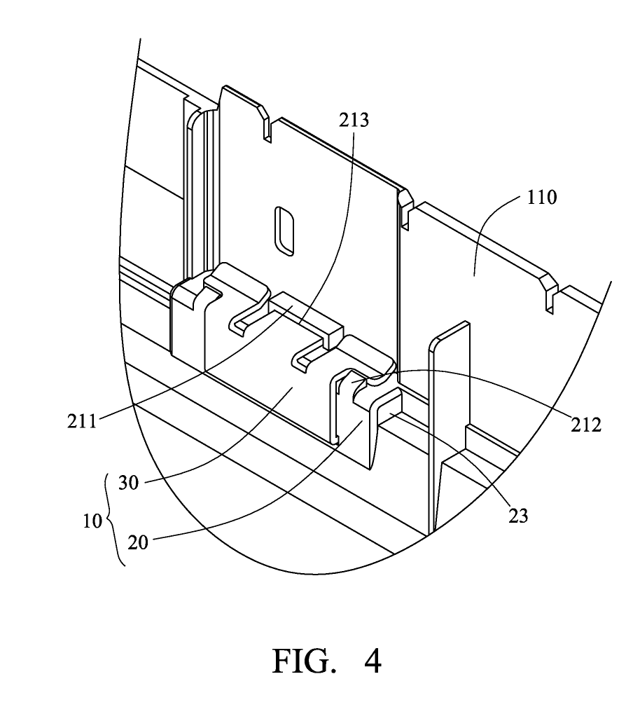

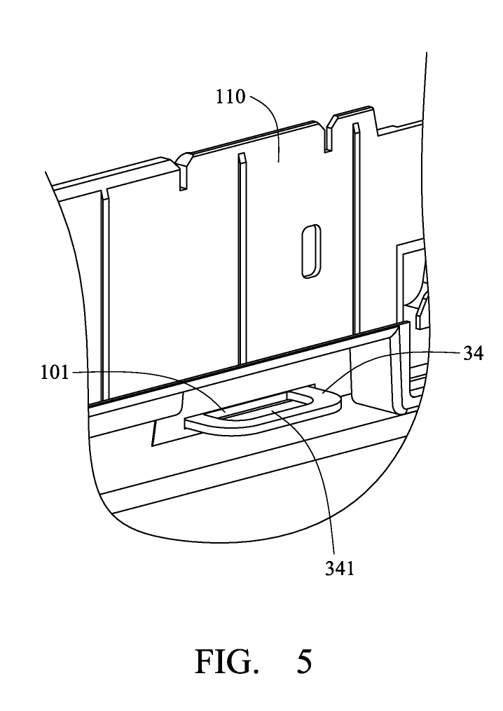

Also referring to FIGS. 3 through 5, the fastener 30 includes a main body 31, a first holding sheet 32, two second holding sheets 33, and a third holding sheet 34 parallel to the first holding sheet 32. The first and second holding sheets 32, 33 extend perpendicularly in a same direction from a top end of the main body 31, and correspond to the upper plate 21. The first holding sheet 32 corresponds to the receiving element 211, and the second holding sheets 33 correspond to the protrusions 212. The third holding sheet 34 extends perpendicularly in the same direction from a bottom end of the main body 31, and corresponds to the through hole 101. The third holding sheet 34 includes the locking hole 341 therein. The first holding sheet 32 is sized and shaped so as to be capable of mating with the receiving element 211. The second holding sheets 33 are sized and shaped so as to be capable of engaging with the protrusions 212 respectively. In detail, each of the two second holding sheets 33 includes a connection portion 331, and a protruding portion 332 extending from the connection portion 331. The protruding portions 332 of the second holding sheets 33 extend from the corresponding connection portions 331 in opposite directions away from the first holding sheet 32. In this embodiment, the protruding portions 332 are capable of elastically deforming.

In forming the locking structure 10, the fastener 30 is engaged with the engagement portion 20. The first holding sheet 33 is inserted into the hole 213, and the third holding sheet 34 is inserted through the through hole 101. The protruding portions 332 ride over curved parts of the protrusions 212 and thereby elastically deform. Finally, when the main body 31 reaches a position where it abuts the lateral plate 22, the protruding portions 332 snappingly deform back to their original shapes and abut vertical faces of the protrusions 212. Thus the second holding sheets 33 are engaged with the protrusions 212, the first holding sheet 32 is mated in the hole 213 of the receiving element 211, and the third holding sheet 34 extends through the through hole 101 such that the locking hole 341 is exposed to the outside of the housing 110.

Moreover, the fastener 30 can be detached from the engagement portion 20 when the locking structure 10 is not required. For example, when the portable electronic device 100 no longer needs to be locked in future, the fastener 30 can be removed.

In summary, the third holding sheet 34 provides the locking hole 341 for easy locking. That is, the third holding sheet 34 serves as a locking loop, so that the portable electronic device 100 can be conveniently locked to another locking loop by, for example, a padlock. In many instances, the padlock will be able to lock the third holding sheet 34 of another different portable electronic device 100 if and when required. That is, only the one padlock may be needed to lock different portable electronic devices 100. This can save on costs.

While the embodiments have been described by way of example herein, it is to be understood that the embodiments are not limited thereto. To the contrary, various modifications and similar arrangements (as would be apparent to those skilled in the art) are intended to be covered. Therefore, the scope of the appended claims should be accorded the broadest interpretation so as to encompass all such modifications and similar arrangements.

What is claimed is:

1. A locking structure for a portable electronic device, the portable electronic device comprising a housing, the locking structure comprising:
an engagement portion including an upper plate and a lateral plate substantially perpendicular to the upper plate, the upper plate including a receiving element and at least one protrusion spaced from the receiving element, the receiving element comprising a hole aligned in a same horizontal level with the at least one protrusion, and the lateral plate defining a through hole passing through the housing; and
a fastener including a main body, a first holding sheet, at least one second holding sheet, and a third holding sheet, the first and second holding sheets extending from a top end of the main body, the third holding sheet extending from a bottom end of the main body and having a locking hole defined therein, the first holding sheet capable of mating in the receiving element, the at least one second holding sheet capable of engaging with the at least one protrusion, and the third holding sheet capable of at least partly protruding from the through hole such that the through hole is exposed to the outside of the housing.

2. The locking structure of claim 1, wherein the at least one second holding sheet comprises a connection portion and a protruding portion extending from the connection portion, the protruding portion extending generally away from the first holding sheet.

3. The locking structure of claim 2, wherein the at least one protrusion comprises a curved part, and the protruding portion of the at least one second holding sheet is capable of riding over the curved part when the fastener is engaged with the engagement portion.

4. The locking structure of claim 3, wherein the protruding portion is capable of elastically deforming when it rides over the curved part of the at least one protrusion, and snappingly rebounding into engagement with the at least one protrusion after finishing riding over the curved part of the at least one protrusion.

5. The locking structure of claim 1, wherein the first holding sheet and the at least one second holding sheet extend perpendicularly in a same direction from a top end of the main body and correspond to the upper plate.

6. The locking structure of claim 5, wherein the first holding sheet is sized and shaped so as to be capable of mating with the receiving element.

7. The locking structure of claim 5, wherein the at least one second holding sheet is sized and shaped so as to be capable of engaging with the at least one protrusion.

8. The locking structure of claim 1, wherein the through hole is a rectangular slot.

9. A portable electronic device with locking capability, the portable electronic device comprising:
a housing;
an engagement portion including an upper plate and a lateral plate substantially perpendicular to the upper plate, the upper plate including a receiving element and at least one protrusion spaced from the receiving element, the receiving element comprising a hole aligned in a same horizontal level with the at least one protrusion, and the lateral plate defining a through hole; and
a fastener including a main body, a first holding sheet, at least one second holding sheet, and a third holding sheet, the first holding sheet and the at least one second holding sheet extending from a top end of the main body, the third holding sheet extending from a bottom end of the main body and having a locking hole defined therein, the first holding sheet capable of mating in the receiving element, the at least one second holding sheet capable of engaging with the at least one protrusion, and the third holding sheet capable of at least partly protruding from the through hole such that the through hole is exposed to the outside of the housing.

10. The portable electronic device of claim 9, wherein the at least one second holding sheet comprises a connection portion and a protruding portion extending from the connection portion, the protruding portion extending generally away from the first holding sheet.

11. The portable electronic device of claim 10, wherein the at least one protrusion comprises a curved part, and the protruding portion is capable of riding over the curved part when the fastener is engaged with the engagement portion.

12. The portable electronic device of claim 11, wherein the protruding portion is capable of elastically deforming when it rides over the curved part of the at least one protrusion, and snappingly rebounding into engagement with the at least one protrusion after finishing riding over the curved part of the at least one protrusion.

13. The portable electronic device of claim 9, wherein the first holding sheet and the at least one second holding sheet extend perpendicularly in a same direction from the top end of the main body and correspond to the upper plate.

14. The portable electronic device of claim 13, wherein the first holding sheet is sized and shaped so as to be capable of mating with the receiving element.

15. The portable electronic device of claim 13, wherein the at least one second holding sheet is sized and shaped so as to be capable of engaging with the at least one protrusion.

16. The portable electronic device of claim 9, wherein the through hole is a rectangular slot.

17. A fastener for providing a portable electronic device with locking capability, the portable electronic device comprising a housing, the fastener comprising:
a main body;
a first holding sheet extending from a top end of the main body in a first direction, and configured to engage in a first hole of the housing;
at least one second holding sheet extending from the top end of the main body in the first direction, at least part of the at least one second holding sheet being elastically deformable and configured to be snappingly engaged with the housing; and
a third holding sheet extending from a bottom end of the main body in the first direction and defining a locking hole therein, and capable of extending through a second hole of the housing such that the locking hole is exposed to the outside of the housing.

18. The fastener of claim 17, wherein a distance between the first holding sheet and the third holding sheet is configured to be substantially the same as a distance between the first hole and the second hole.

19. The fastener of claim 17, wherein the at least one second holding sheet comprises a connection portion and a protruding portion extending from the connection portion, the protruding portion extending generally away from the first holding sheet.

20. The fastener of claim 17, wherein the third holding sheet has a substantially rectangular transverse cross-section.
